(19) United States
(12) Patent Application Publication
(10) Pub. No.: US 2019/0009617 A1
(43) Pub. Date: Jan. 10, 2019

(54) TIRE HAVING MICROSIPES ALONG LATERAL EDGES

(71) Applicants: Compagnie Generale des Etablissements Michelin; Michelin Recherche et Technique S.A.

(72) Inventors: Evan Charles Sanders, Honea Path, SC (US); Joseph Nicholas Brown, Simpsonville, SC (US)

(21) Appl. No.: 15/317,525

(22) PCT Filed: Jun. 23, 2015
(86) PCT No.: PCT/US15/37070

§ 371 Date: Dec. 9, 2016

Related U.S. Application Data
(60) Provisional application No. 62/016,710, filed on Jun. 25, 2014.

(51) Int. Cl. B60C 11/12; B60C 11/13; B60C 11/03

(52) U.S. Cl. CPC B60C 11/1236; B60C 11/1392; B60C 2011/1231; B60C 11/1204; B60C 11/0306

(57) ABSTRACT

A tire is provided with a tread having microsipes along lateral edges such as the leading edge, trailing edge, or both of various tread features. The microsipes are oriented substantially along the longitudinal direction. In contravention of conventional teachings, the addition of these microsipes has been found to improve rolling resistance, dry braking, or both. The microsipes can be located along edges that are chamfered as well.

### PRIORITY STATEMENT

The present application claims priority under 35 U.S.C. § 119 to Provisional Application No. 62/016,710, filed Jun. 25, 2014.

### FIELD OF THE INVENTION

The subject matter of the present disclosure relates generally to microsipes along lateral edges a tire's tread features such as e.g., the leading edge and trailing edge.

### BACKGROUND OF THE INVENTION

The design and manufacture of a tire typically requires consideration of numerous criteria including aesthetics, acoustics, energy efficiency, fraction, and braking performance under various anticipated road conditions and other concerns as well. Unfortunately, under conventional designs, the improvement of one performance criterion occurs at the expense of another. As such, tire designers may be forced to choose a compromise between these competing considerations.

One such example is the conventional compromise between traction and rolling resistance. Increased rolling resistance is undesirable because of its deleterious effect on a vehicle's fuel economy. In general, an improvement in traction will usually cause an increase in rolling resistance or an improvement in rolling resistance will usually result in a decrease in traction such as dry braking traction. If, for example, the composition of the rubber formulation is modified to improve braking performance, the rolling resistance is undesirably increased. Reducing tread depth can offer benefits for both dry braking and rolling resistance but typically comes at the expense of a decrease in wet or snow traction.

Tire design may also include the addition of tread features to control wear problems. For example, sipes have been applied to the sides of tire ribs in an effort to improve irregular wear problems particularly for tires used on commercial vehicles. However, depending upon e.g., the size and density, the addition of such sipes comes with an increase in rolling resistance and/or a decrease in handling performance.

Accordingly, tread features that can be used to improve the performance of a tire would be useful. More particular, tread features that can be added to a tire to improve its traction braking performance without increasing rolling resistance would be particularly beneficial.

### SUMMARY OF THE INVENTION

The present invention provides a tire tread having microsipes along lateral edges such as the leading edge, trailing edge, or both of various tread features. The microsipes are oriented substantially along the longitudinal direction. In contravention of conventional teachings, the addition of these microsipes has been found to improve rolling resistance, dry braking, or both. The microsipes can be located along edges that are chamfered as well. Additional objects and advantages of the invention will be set forth in part in the following description, or may be apparent from the description, or may be learned through practice of the invention.

In one exemplary embodiment, the present invention provides a tire defining longitudinal, radial, and axial directions. The tire includes a pair of opposing shoulders spaced apart along the axial direction with a tread portion extending between the shoulders. The tread portion includes a plurality of tread features, wherein each tread feature includes at least one leading edge extending along the axial direction and one trailing edge extending along the axial direction. A plurality of microsipes are positioned along the leading edge, the trailing edge, or both. The microsipes extends along the longitudinal direction and are positioned adjacent to each other.

In another exemplary embodiment, the present invention provides a tire that includes a tread portion extending along an axial direction of the tire between opposing shoulder portions. A plurality of tread blocks are positioned adjacent to each other along a longitudinal direction of the tire. The tread blocks are separated from each other by grooves, each tread block having a leading edge and a trailing edge adjacent to the grooves and extending along the axial direction. A plurality of microsipes are positioned along the leading edge, trailing edge, or both of the tread blocks. The microsipes extending longitudinally and arranged in a parallel and adjacent configuration.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a front view of an exemplary embodiment of a tread portion for a tire of the present invention.

FIG. 2 illustrates a close-up, front view of exemplary tread blocks of the present invention.

FIG. 3 is a close-up, front view of a portion of the leading edge of the exemplary tread block of FIG. 2.

FIG. 4 provides a side view of the exemplary tread block of FIGS. 2 and 3.

FIG. 5 provides a side view of another exemplary tread block of the present invention.

FIGS. 6, 7, 8, and 9 illustrate graphs of various data from testing as will be further described herein.

### DETAILED DESCRIPTION

For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

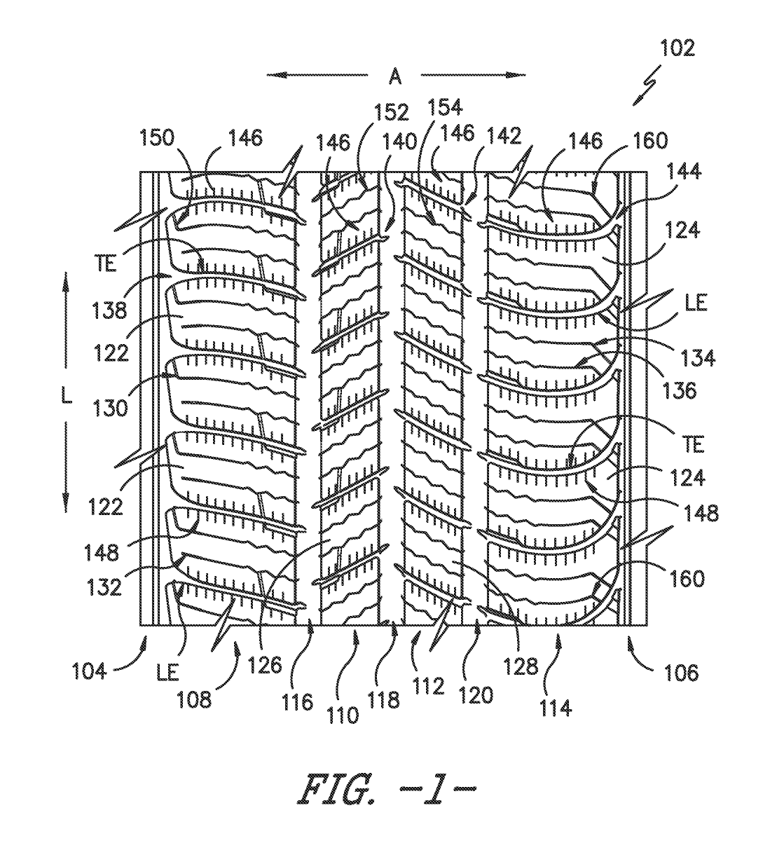

FIG. 1 is a front view of an exemplary tread portion 102 for a tire of the present invention. As shown, tread portion 102 extends along an axial direction A between opposing shoulders 104 and 106 of the tire. Axial direction A (also referred to as the lateral direction) is parallel to the axis of rotation of a tire upon which tread portion 102 is located. Tread portion 102 repeats along longitudinal direction L, which extends circumferentially around the axis of rotation of the tire and is orthogonal to axial direction A at any given point on tread portion 102. It should be understood that the present invention is not limited to the particular pattern or aesthetics for a tire as shown in FIG. 1. The appearance and configuration of tread portion 102 is provided by way of example; tread portions of other shapes and configurations may be used as well.

For this exemplary embodiment, tread portion 102 includes several rows 108, 110, 112, and 114 of tread features separated by grooves 116, 118, and 120 that each extend along longitudinal direction L. Exterior rows 108 and 114 include a plurality of tread blocks 122 and 124 separated by lateral grooves 138 and 144, respectively. Interior rows 112 and 144 include a plurality of tread blocks 126 and 128 separated by lateral grooves 140 and 142, respectively. Each tread block 122, 124, 126, and 128 includes a leading edge LE and a trailing edge TE. Sipes 150, 152, 154, and 160 of different shapes and lengths are also defined by tread blocks 122, 124, 126, and 128, respectively. Although each tread block is show with a pair of sipes extending along the axial direction, a different number and configuration may be used as well in other embodiments of the invention.

Continuing with FIG. 1, for this exemplary embodiment, the trailing edge LE and leading edge LE of each tread block 122, 124, 126, and 128 defines a plurality of microsipes 146 and 148. Each microsipe 146 and 148 is oriented or extends along longitudinal direction L. Microsipes 146 are arranged parallel and adjacent to each other along trailing edge TE while microsipes 148 are arranged parallel and adjacent to each other along leading edge LE. Although a certain number of microsipes 146 and 148 are shown on each leading edge LE and trailing edge TE, in other exemplary embodiments of the invention a different number may be used as well. In addition, the present invention does not require microsipes along both the leading edge and trailing edge of each tread feature such as e.g., tread blocks 122, 124, 126, and 128. Instead, in other embodiments of the invention, microsipes may be placed only on leading edge LE or only upon trailing edge TE.

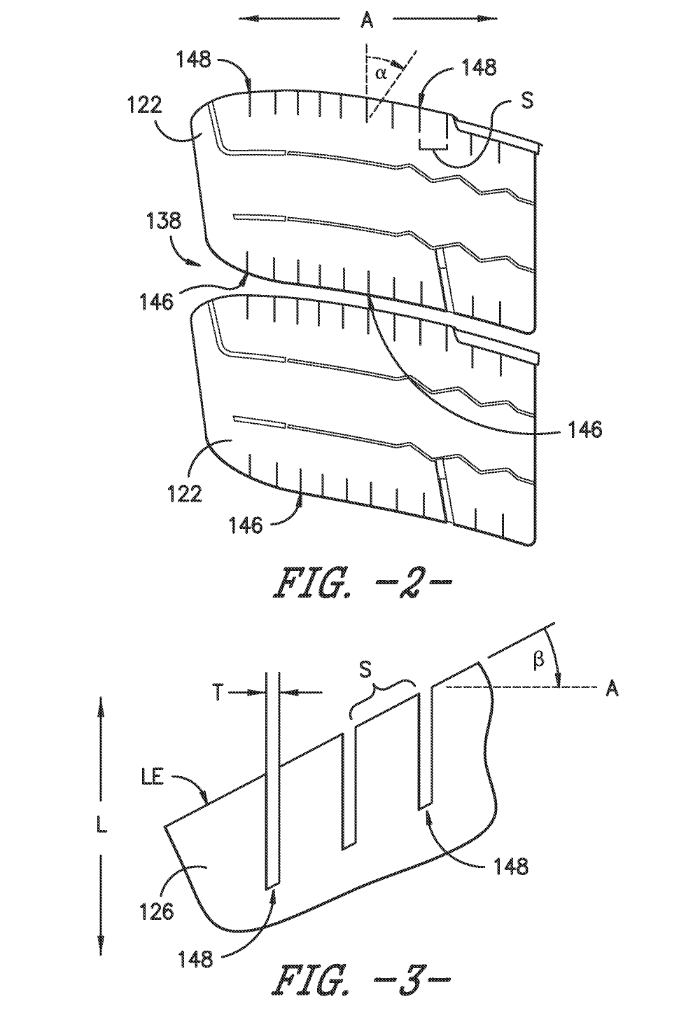

FIGS. 2, 3, and 4 illustrate additional aspects of exemplary microsipes 146 and 148. As stated, microsipes 146 and 148 are oriented along the longitudinal direction L. Using microsipes 148 by way of example, the microsipes form an angle α with longitudinal direction L that is in the range of zero degrees to 10 degrees or, in another exemplary embodiment, is in the range of zero degrees to 5 degrees. As used herein, “in the range of” or “within the range of” includes the endpoints of the stated range. In still another embodiment of the invention, angle α is zero degrees.

As shown in FIG. 2, microsipes 146 and 148 are spaced apart from each other along leading edge LE and trailing edge TE by a predetermined distance S. In one exemplary embodiment, predetermined distance S is in the range of 4 mm to 6 mm. In still another exemplary embodiment, predetermined distance S is about 5 mm. As used herein, “about” means±0.1 mm.

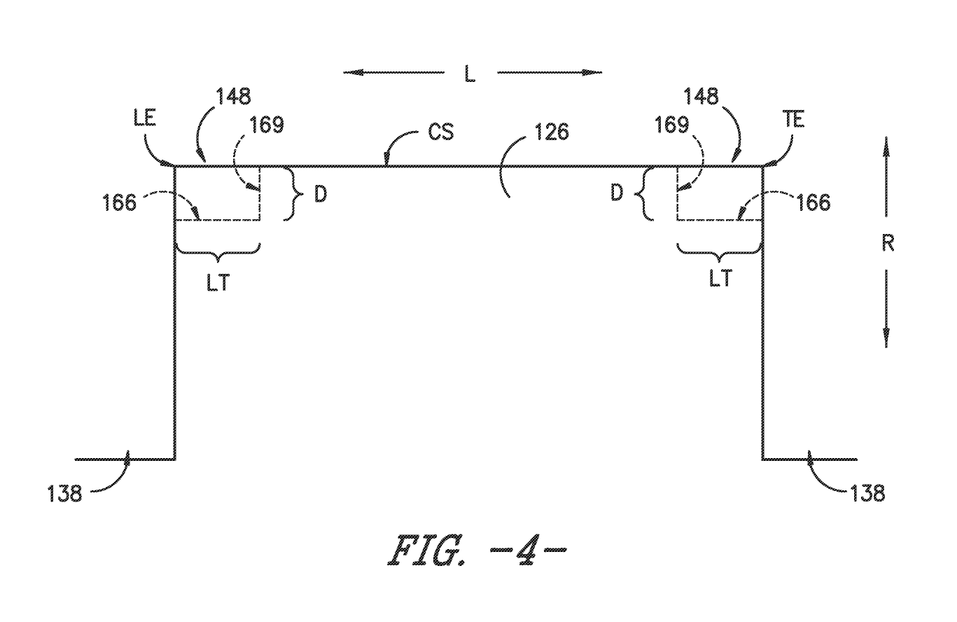

Referring to FIG. 3, using microsipe 148 in tread block 126 by way of example, each microsipe has a predetermined thickness T along the axial direction L as shown. Each microsipe 146 and 148 may be formed e.g., during molding of tread portion 102 by insertion of a thin molding element into tread block 126. Other methods may be used as well. In one exemplary embodiment, predetermined thickness T may be in the range of 0.4 mm to 0.8 mm. In another exemplary embodiment, microsipes have a predetermined thickness T of about 0.6 mm.

In certain exemplary embodiments of a tread portion 102 of the present invention, the leading edge LE of a tread feature such as tread blocks 122, 124, 126, and 128 may be substantially linear in shape as shown. Such leading edge LE can form a predetermined angle β with the longitudinal direction L as shown in FIG. 3. In one exemplary embodiment, angle β is in the range of 0 to 45 degrees. In another exemplary embodiment, angle β is in the range of 0 to 20 degrees. In still another exemplary embodiment, angle β is zero degrees.

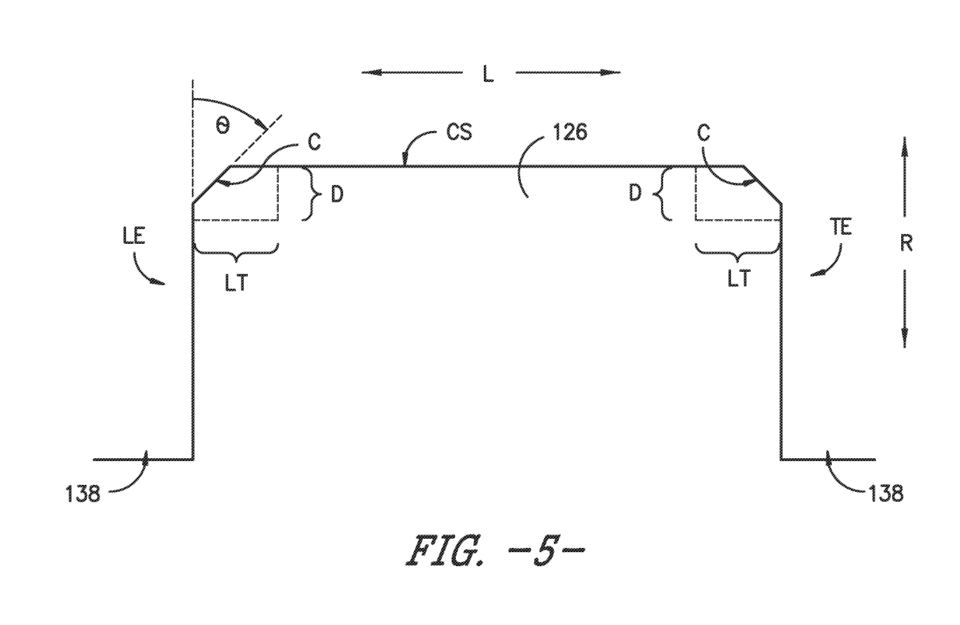

FIG. 4 provides a side view of a tread block 126 used here by way of example to describe the predetermined depth D (from contact surface CS) and length LT (from the tread block edge) of microsipes 146 and 148. As shown, microsipes 146 have a bottom 162 and side 164, while microsipes 148 have a bottom 166 and side 168. In one exemplary embodiment, predetermined depth D along radial direction R is in the range of 0.5 mm to 2.5 mm for one or both of microsipes 146 and 148. In another exemplary embodiment, predetermined depth D along radial direction R is about 2 mm for one or both of microsipes 146 and 148.

Still referring to FIG. 4, in one exemplary embodiment, microsipes 146 and/or 148 have a predetermined length LT along the longitudinal direction L in the range of 2.5 mm to 5 mm. In another exemplary embodiment, microsipes 146 and/or 148 have a predetermined length LT in the range of 3 mm to 3.5 mm.

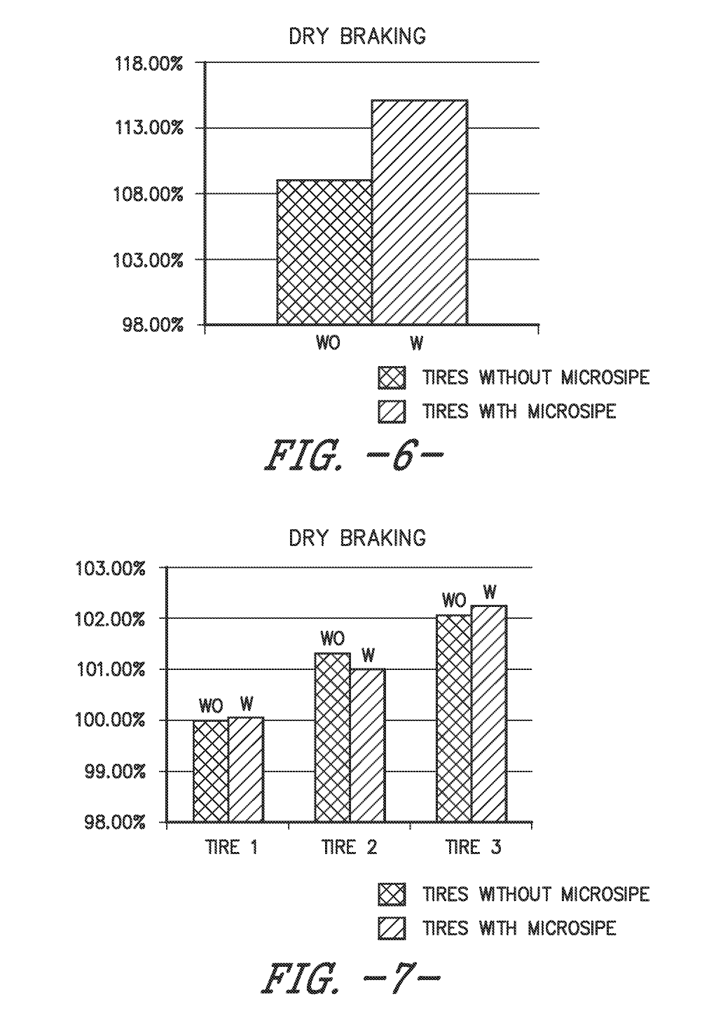

For the exemplary embodiment of FIGS. 1 through 4, leading edge LE and trailing edge TE are shown with a substantially square profile along axial direction A as best viewed in FIG. 4. Other shapes may be used as well for leading edge LE, trailing edge TE, or both. Using tread block 126 by way of example, FIG. 5 shows leading edge LE and trailing edge TE with a chamfer C to remove the square profile along the axial direction. This embodiment may be particularly beneficial for avoiding undesirable noise that can be generated by other shapes. The chamfered edge may be used on one, all, or various combinations of the tread features 122, 124, 126, and 128 depicted in FIG. 1. In one exemplary embodiment, chamfer C forms an angle θ from radial direction R of 45 degrees as shown.

For the exemplary embodiments just described, the microsipes were located on the leading edge LE and trailing edge TE of a tread block. Using the teachings disclosed here, however, one of skill in the art will understand that microsipes could be located along other lateral edges of a tread feature such as e.g., edges on either side of a lateral groove in a tread block or a rib. As used herein, “lateral edge” means an edge that forms an angle θ of 45 degrees of less from axial direction A as shown in FIG. 3.

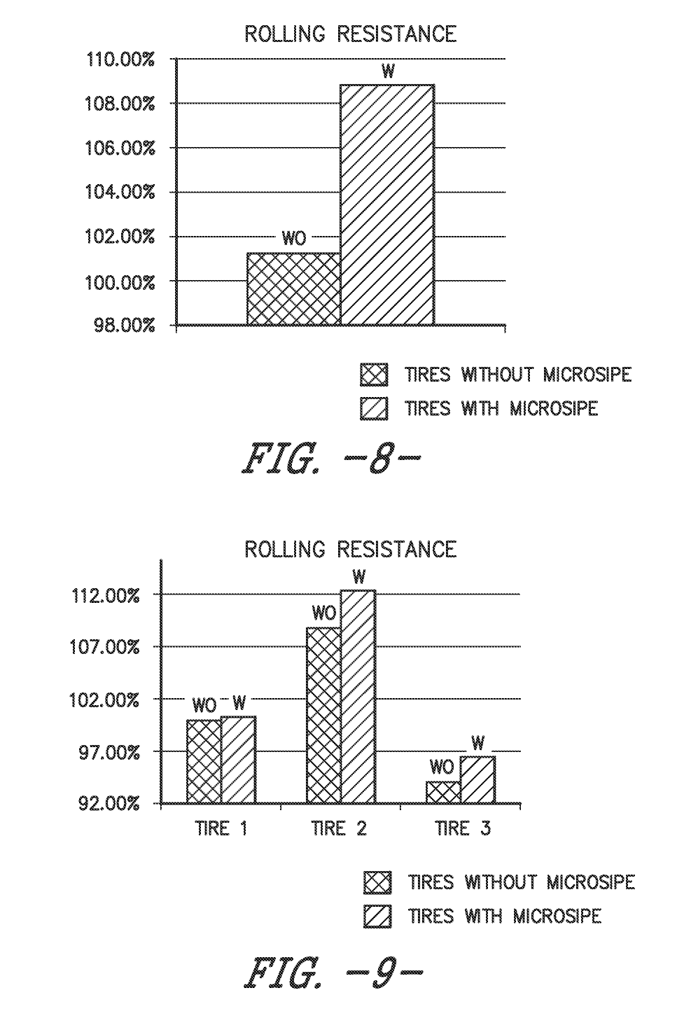

As will be further described, FIGS. 6 through 9 provide graphs of certain test data obtained by comparative testing of two tires of size 245/40R19 on a vehicle. The reference tires, referred to in the graphs as WO, had a tread portion with various tread features and did not include microsipes as described herein. The test tires, referred to in the graphs as W, included a tread portion with the same tread features as the reference tires except microsipes were also included along the leading and trailing edges of the tread blocks for each longitudinal row of the tread portion. Table I below provides information regarding the microsipes used on the test tires.

TABLE I

| | Tread | | Tread | | Tread | | Tread | | Tread | |
|---|---|---|---|---|---|---|---|---|---|---|
| | Rib 1 | | Rib 2 | | Rib 3 | | Rib 4 | | Rib 5 | |
| Number of | 7 | | 5 | | 5 | | 6 | | 7 | |
| Microsipes | | | | | | | | | | |
| Spacing | 5 | mm | 5 | mm | 5 | mm | 5 | mm | 5 | mm |
| Between | | | | | | | | | | |
| Microsipes | | | | | | | | | | |
| Microsipe | 0.8 | mm | 0.8 | mm | 0.8 | mm | 0.8 | mm | 0.8 | mm |
| Thickness | | | | | | | | | | |
| Microsipe | 2 | mm | 2 | mm | 2 | mm | 2 | mm | 2 | mm |
| Depth | | | | | | | | | | |
| Microsipe | 3 | mm | 3.5 | mm | 3.5 | mm | 3.5 | mm | 3 | mm |
| Length | | | | | | | | | | |

As now discussed, the results of the testing are surprising and contradict conventional teachings regarding the anticipated impact on rolling resistance and fraction during dry braking (descriptions of the test methods used are provided below). For example, FIG. 6 shows that in a first round of testing tire W having a tread with microsipes had a 6 percent improvement in rolling resistance compared to tire WO having the same tread but no microsipes. This improvement is comparable or even better to improvements in rolling resistance obtainable by only changing the rubber formulation for the tire. FIG. 7 illustrates that in a second round of testing, in 2 of 3 trials, tire W exhibited improved braking over tire WO.

FIG. 8 indicates that tire W with microsipes provided a substantial improvement (8 to 10 percent) in rolling resistance over the same tire WO without microsipes—in a first round of testing.

For a second round of rolling resistance testing, three different tires with three different treads were used. As shown in FIG. 9, tires W with microsipes continued to show improvement over tires WO without microsipes.

Test Method Description—Dry Braking Test Method

The purpose of this test was to evaluate the braking performance of the tires on a vehicle. The test consists of a statistical analysis of stopping distances plus comments by the driver. One dry track is used for this test. Measurement of stopping distance is made with a calibrated accelerometer-based instrument. A microprocessor calculates speed and distance while perform vehicle tests. To begin the test on a set of tires, the driver makes one practice run to gain familiarity with the characteristics of the tires and to warm the brakes. At least six additional runs are then made and the results are recorded. Typically, 60 mph is used for dry braking. At a predetermined point, marked with a pylon, the driver applies the brakes and brings the vehicle to a stop as quickly as possible. The driver then records the initial speed and stopping distance that are displayed on the microprocessor. After completing the test for one set of tires, the driver records comments on a worksheet. Generally, the driver should try to maintain a ±1 mph variation about the target speed. Six speeds and stopping distances for each tire set are reported. A corrected stopping distance for each run is calculated.

Test Method Description—ISO28580 Rolling Resistance Method

The purpose of this test was to measure rolling resistance and revolutions per mile under one load/pressure combination for 30 minutes at 80 kilometers per hour. The results are corrected to a 2 meter road wheel. Results are reported both with and without skim measurement.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

1. A tire defining longitudinal, radial, and axial directions, the tire comprising:
a pair of opposing shoulders spaced apart along the axial direction;
a tread portion extending between the shoulders, the tread portion comprising
a plurality of tread features, wherein each tread feature includes at least one leading edge extending along the axial direction and one trailing edge extending along the axial direction; and
a plurality of microsipes positioned along the leading edge, the trailing edge, or both, the microsipes extending along the longitudinal direction and positioned adjacent to each other, wherein the microsipes form an angle with the longitudinal direction that is in the range of 0 degrees to 10 degrees.

2. The tire of claim 1, wherein the tread features comprise discrete tread blocks separated from each other along the axial and longitudinal direction by a plurality of grooves.

3. The tire of claim 1, wherein the leading edge, the trailing edge, or both, are chamfered.

4. The tire of claim 1, wherein the microsipes form an angle with the longitudinal direction that is in the range of 0 degrees to 10 degrees.

5. The tire of claim 1, wherein the leading edge forms an angle with the longitudinal direction that is in the range of 0 degrees to 45 degrees.

6. The tire of claim 1, wherein the microsipes are spaced apart along the leading edge by a distance in the range of 4 mm to 6 mm.

7. The tire of claim 1, wherein the microsipes are spaced apart along the leading edge by a distance of about 5 mm.

8. The tire of claim 1, wherein the microsipes have a thickness in the range of 0.4 mm to 0.8 mm.

9. The tire of claim 1, wherein the microsipes have a thickness of about 0.6 mm.

10. The tire of claim 1, wherein the microsipes have a depth in the range of 0.5 mm to 2.5 mm.

11. The tire of claim 1, wherein the microsipes have a depth of 2 mm.

12. The tire of claim 1, wherein the microsipes have a length along the longitudinal direction in the range of 2.5 mm to 5 mm.

13. The tire of claim 1, wherein the microsipes have a length along the longitudinal direction in the range of 3 mm to 3.5 mm.

14. A tire, comprising;
a tread portion extending along an axial direction of the tire between opposing shoulder portions;
a plurality of tread blocks positioned adjacent to each other along a longitudinal direction of the tire, the tread blocks separated from each other by grooves, each tread block having a leading edge and a trailing edge adjacent to the grooves and extending along the axial direction; and
a plurality of microsipes positioned along the leading edge, trailing edge, or both of the tread blocks, the microsipes extending longitudinally and arranged in a parallel and adjacent configuration.

15. The tire of claim 14, wherein the leading edge, the trailing edge, or both, are chamfered.

16. The tire of claim 14, wherein the microsipes form an angle with the longitudinal direction that is in the range of 0 degrees to 10 degrees.

17. The tire of claim 14, wherein the leading edge forms an angle with the longitudinal direction that is in the range of 0 degrees to 45 degrees.

18. The tire of claim 14, wherein the microsipes are spaced apart along the leading edge by a distance in the range of 4 mm to 6 mm.

19. The tire of claim 14, wherein the microsipes are spaced apart along the leading edge by a distance of about 5 mm.
